(19) United States
(12) Patent Application Publication
(10) Pub. No.: US 2026/0092587 A1
(43) Pub. Date: Apr. 2, 2026

(54) FUEL LEAK DIAGNOSTIC SYSTEM

(71) Applicant: TOYOTA JIDOSHA KABUSHIKI KAISHA, Toyota-shi (JP)

(72) Inventors: Hiromitsu SEO, Toyota-shi (JP); Jun TAHARA, Toyota-shi (JP); Eiji NAKAMORI, Nagakute-shi (JP); Noboru ONISHI, Toyota-shi (JP); Muneho NATORI, Toyota-shi (JP)

(73) Assignee: TOYOTA JIDOSHA KABUSHIKI KAISHA, Toyota-shi (JP)

(21) Appl. No.: 19/217,283

(22) Filed: May 23, 2025

(30) Foreign Application Priority Data
Sep. 27, 2024 (JP) 2024-168399

(51) Int. Cl. F02M 65/00; G01M 3/00; G01M 3/26

(52) U.S. Cl. CPC F02M 65/006; G01M 3/002; G01M 3/26

(57) ABSTRACT

A fuel leak diagnostic system includes: a high-pressure pump configured to pressurize liquid fuel supplied from a fuel tank; a pressure accumulator configured to store the liquid fuel discharged from the high-pressure pump; an in-cylinder injection valve configured to inject the liquid fuel in the pressure accumulator directly into a cylinder of an engine; and a diagnostic device configured to diagnose a leak of the liquid fuel from the in-cylinder injection valve.

### CROSS-REFERENCE TO RELATED APPLICATION

This application claims priority to Japanese Patent Application No. 2024-168399 filed on Sep. 27, 2024. The disclosure of the above-identified application, including the specification, drawings, and claims, is incorporated by reference herein in its entirety.

### BACKGROUND

### 1. Technical Field

The present disclosure relates to fuel leak diagnostic systems.

### 2. Description of Related Art

There is a technique for diagnosing a gas fuel leak from a gas engine (see, for example, Japanese Unexamined Patent Application Publication No. H11-107860 (JP H11-107860 A)).

### SUMMARY

Liquid fuel may also leak from an in-cylinder injection valve of an engine that uses liquid fuel.

An object of the present disclosure is to provide a fuel leak diagnostic system with improved diagnostic accuracy for a liquid fuel leak from an in-cylinder injection valve of an engine.

This object can be achieved by a fuel leak diagnostic system including:
a high-pressure pump configured to pressurize liquid fuel supplied from a fuel tank;
a pressure accumulator configured to store the liquid fuel discharged from the high-pressure pump;
an in-cylinder injection valve configured to inject the liquid fuel in the pressure accumulator directly into a cylinder of an engine; and
a diagnostic device configured to diagnose a leak of the liquid fuel from the in-cylinder injection valve.
   The diagnostic device includes
an acquisition unit configured to acquire a first temperature and a first pressure of the liquid fuel and a second temperature and a second pressure of the liquid fuel. The first temperature and the first pressure are the temperature and the pressure of the liquid fuel in the pressure accumulator when the engine is in a stopped state. The second temperature and the second pressure are the temperature and the pressure of the liquid fuel in the pressure accumulator after the engine is stopped and before the engine is started.
   The diagnostic device further includes
a determination unit configured to determine whether the second temperature is higher than the first temperature, and
a first calculation unit configured to, when the determination unit makes an affirmative determination, calculate an ideal pressure of the liquid fuel based on the first temperature, the second temperature, the second pressure, the volume of the pressure accumulator, the coefficient of thermal expansion of the liquid fuel, and the bulk modulus of the liquid fuel, assuming that there is no leak of the liquid fuel from the in-cylinder injection valve while the engine is stopped. The ideal pressure is an ideal pressure of the liquid fuel in the pressure accumulator before the engine is started.
   The diagnostic device further includes
a second calculation unit configured to calculate the amount of leakage of the liquid fuel from the in-cylinder injection valve while the engine is stopped, based on the difference between the ideal pressure and the second pressure, and
a diagnostic unit configured to diagnose the leak of the liquid fuel from the in-cylinder injection valve, based on the amount of leakage.

The first calculation unit may be configured to calculate the ideal pressure using the following equation:

$$Pi = P 1 + ( β \times K ) \times ( T 2 - T 1 ) ,$$

where Pi represents the ideal pressure,
P1 represents the first pressure,
β represents the coefficient of thermal expansion,
K represents the bulk modulus,
T2 represents the second temperature, and
T1 represents the first temperature.
   The second calculation unit may be configured to calculate the amount of leakage using the following equation:

$$Δ V = ( 1 / K ) \times ( Pi - P 2 ) \times V ,$$

where ΔV represents the amount of leakage,
P2 represents the second pressure, and
V represents the volume.

The diagnostic device may further include
a measurement unit configured to measure a start time taken to start the engine, and
a count unit configured to increment a counter value when the amount of leakage is equal to or larger than a predetermined amount and the start time is equal to or longer than a predetermined time.
   The diagnostic unit may be configured to diagnose that the liquid fuel is leaking from the in-cylinder injection valve, when the counter value is equal to or larger than a predetermined value.

The count unit may be configured to decrement the counter value when the amount of leakage is equal to or larger than the predetermined amount and the start time is less than the predetermined time.

The fuel leak diagnostic system may further include a low-pressure pump configured to pressurize the liquid fuel stored in the fuel tank to supply the pressurized liquid fuel to the high-pressure pump and a port injection valve of the engine.

The present disclosure provides a fuel leak diagnostic system with improved diagnostic accuracy for a liquid fuel leak from an in-cylinder injection valve of an engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a fuel leak diagnostic system; and

FIG. 2 is a flowchart illustrating the fuel leak diagnostic control on the in-cylinder injection valve that is executed by an ECU.

### DETAILED DESCRIPTION OF EMBODIMENTS

### Overview of Fuel Leak Diagnostic System

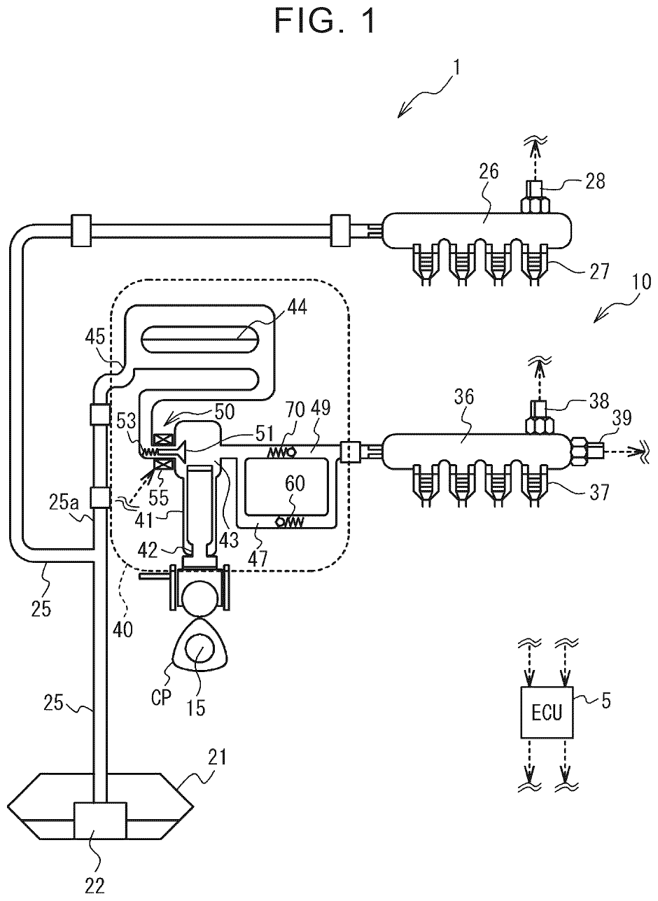

FIG. 1 is a schematic configuration diagram of a fuel leak diagnostic system 1. The fuel leak diagnostic system 1 includes an engine 10, a fuel tank 21, a low-pressure pump 22, a low-pressure pipe 25, a low-pressure delivery pipe 26, a high-pressure delivery pipe 36, fuel pressure sensors 28, 38, a fuel temperature sensor 39, a high-pressure pump 40, an ECU (Electronic Control Unit) 5, etc. The fuel leak diagnostic system 1 is mounted on, for example, a vehicle using the engine 10 as a driving power source, but is not limited thereto.

The engine 10 is a spark ignition four-cylinder gasoline engine including in-cylinder injection valves 37 that inject fuel into cylinders, and port injection valves 27 that inject fuel into intake ports. However, the engine 10 is not limited to this, and may be, for example, a diesel engine, an alcohol engine, or a direct injection engine that does not include the port injection valves 27 and the low-pressure delivery pipe 26. Further, the engine 10 includes a camshaft 15 that drives an intake valve or an exhaust valve in conjunction with a crankshaft that is interlocked with a plurality of pistons.

The fuel tank 21 stores gasoline that is liquid fuel. When the engine 10 is a diesel engine, the liquid fuel is light oil. When the engine 10 is an alcohol engine, the liquid fuel is alcohol. The low-pressure pump 22 pressurizes the fuel and discharges it to the low-pressure pipe 25. The fuel discharged into the low-pressure pipe 25 is supplied to the port injection valves 27 via the low-pressure delivery pipe 26, and is also supplied to the high-pressure pump 40 via the branch pipe 25a branched from the low-pressure pipe 25.

The high-pressure pump 40 pressurizes the fuel supplied from the branch pipe 25a and discharges the fuel to the high-pressure delivery pipe 36. The fuel pressurized by the high-pressure pump 40 is supplied to the in-cylinder injection valves 37 via the high-pressure delivery pipe 36.

The fuel pressure sensors 28, 38 detect the fuel pressure in the low-pressure delivery pipe 26 and the high-pressure delivery pipe 36, respectively. The fuel temperature sensor 39 detects the temperature of the fuel in the high-pressure delivery pipe 36. The ECU 5 acquires the detected values of the fuel pressure sensors 28, 38 and the fuel temperature sensor 39.

The ECU 5 includes a CPU (Central Processing Unit), a RAM (Random Access Memory), a ROM (Read Only Memory), and a rewritable nonvolatile memory, and executes an anomaly diagnostic control of a fuel pressure sensor 38, which will be described later, by the CPU executing a program stored in the ROM. The abnormal diagnostic control of the fuel pressure sensor 38 is performed by the acquisition unit, the determination unit, the first calculation unit, the second calculation unit, the diagnostic unit, the measurement unit, and the count unit that are functionally implemented by the CPU, the ROM, the RAM, 10 and the nonvolatile memory. This will be described in detail later.

The ECU 5 changes the in-cylinder injection rate, namely is the ratio of the fuel injection amount injected from the in-cylinder injection valves 37 to the total fuel injection amount, according to the operating area of the engine 10. For example, the in-cylinder injection ratio is 0% in a low-load operating region of the engine 10, is 100% in a high-load operating region, and is set to an intermediate value therebetween in the medium-load region.

### Schematic Configuration of High-Pressure Pump

The high-pressure pump 40 will be described. The high-pressure pump 40 is provided with a cylinder 41, a plunger 42, a pressurizing chamber 43, an intake passage 45, a discharge passage 47, a relief passage 49, an intake valve 50, a discharge valve 60, and a relief valve 70.

The plunger 42 reciprocates in the cylinder 41 in conjunction with the driving of the engine 10. Specifically, the plunger 42 is biased by a spring toward the cam CP rotating together with the camshaft 15, and reciprocates in the cylinder 41 by the rotation of the cam CP.

The pressurizing chamber 43 is defined by the cylinder 41 and the plunger 42, and the volume of the pressurizing chamber 43 decreases due to the increase of the plunger 42, and the volume of the pressurizing chamber 43 increases due to the decrease of the plunger 42.

The intake passage 45 communicates the branch pipe 25a branched from the low-pressure pipe 25 with the pressurizing chamber 43. The intake passage 45 is provided with a pulsation damper 44 that suppresses fuel pressure pulsation. The relief passage 49 communicates with the pressure chamber 43 and the high-pressure delivery pipe 36. The discharge passage 47 communicates the relief passage 49 closer to the pressurizing chamber 43 than the discharge valve 60 with the relief passage 49 closer to the high-pressure delivery pipe 36 than the discharge valve 60. That is, the discharge passage 47 bypasses the relief valve 70.

The intake valve 50 is an electromagnetically driven on-off valve that is provided on the fuel inlet side of the pressurizing chamber 43 and switches the communication state between the intake passage 45 and the pressurizing chamber 43. The intake valve 50 includes a valve body 51, a coil 55 that drives the valve body 51, and a spring 53 that constantly biases the valve body 51 in the opening direction. The energization of the coil 55 is controlled by the ECU 5. When the coil 55 is energized, the valve body 51 shuts off the intake passage 45 and the pressurizing chamber 43 against the biasing force of the spring 53. When the coil 55 is in the non-energized state, the valve body 51 is maintained in the open state by the biasing force of the spring 53.

The discharge valve 60 is provided on the discharge passage 47, and is a check valve that allows the flow of fuel from the pressurizing chamber 43 side to the high-pressure delivery pipe 36 side but restricts the flow in the reverse direction. Specifically, the discharge valve 60 is opened when the fuel pressure in the pressurizing chamber 43 becomes higher than the fuel pressure in the high-pressure delivery pipe 36 by a predetermined amount.

In the intake stroke of the high-pressure pump 40, the intake valve 50 opens and the plunger 42 descends, and the fuel is filled from the branch pipe 25a into the pressurizing chamber 43 via the intake passage 45. In the pressurizing stroke, the volume of the pressurizing chamber 43 decreases as the intake valve 50 closes and the plunger 42 rises, and the fuel in the pressurizing chamber 43 is pressurized. In the discharge stroke, when the force of the fuel pressure acting on the discharge valve 60 from the pressurizing chamber 43 side increases due to the force of the fuel pressure acting on the discharge valve 60 from the high-pressure delivery pipe 36 side and the biasing force of the spring of the discharge valve 60, the discharge valve 60 opens, and the pressurized fuel is supplied to the high-pressure delivery pipe 36.

The relief valve 70 is provided on the relief passage 49, and is a check valve that allows the fuel to flow from the high-pressure delivery pipe 36 to the pressurizing chamber 43 but does not allow the fuel to flow in the reverse direction. The relief valve 70 is opened when the fuel pressure in the high-pressure delivery pipe 36 excessively rises to such an extent that an abnormality can occur in the high-pressure delivery pipe 36 or the in-cylinder injection valves 37, thereby reducing the occurrence of an abnormality in these.

As described above, the high-pressure fuel is accumulated in the high-pressure delivery pipe 36, the space closer to the high-pressure delivery pipe 36 than the discharge valve 60 of the discharge passage 47, and the space closer to the high-pressure delivery pipe 36 than the relief valve 70 of the relief passage 49. Therefore, these are examples of a pressure accumulator that stores the liquid fuel discharged from the high-pressure pump 40.

### Fuel Leak Diagnostic Control

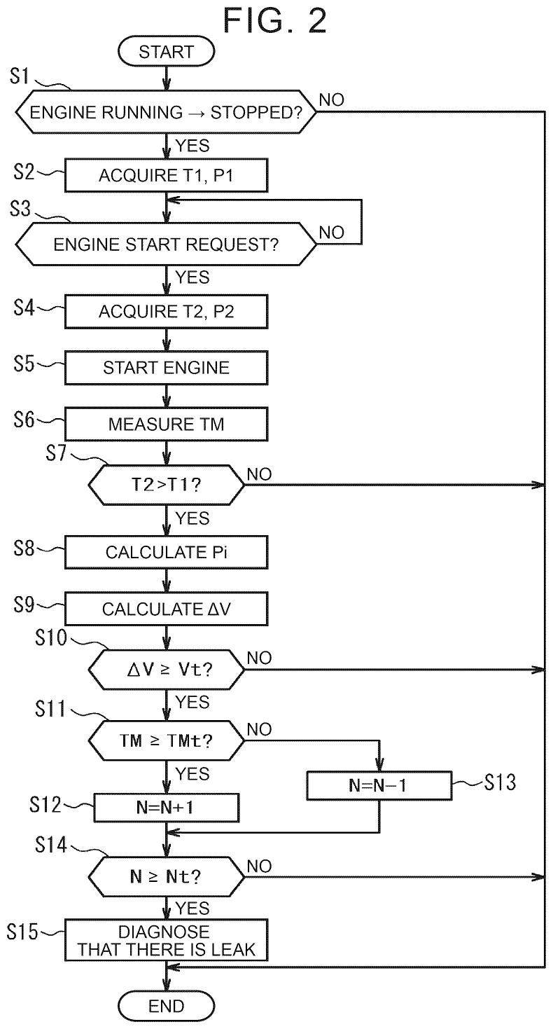

Therefore, the ECU 5 executes the fuel leak diagnostic control on the in-cylinder injection valve 37 as follows. FIG. 2 is a flowchart illustrating the fuel leak diagnostic control on the in-cylinder injection valve 37 that is executed by the ECU 5. The ECU 5 repeatedly executes the present control at predetermined intervals during the ignition-on. The ECU 5 determines whether the engine 10 has changed from a running state to a stopped state (S1). The stopped state of the engine 10 includes when the vehicle is stopped due to the ignition off, when the engine 10 is temporarily stopped due to the stop-start function, when the engine 10 of a hybrid electric vehicle is intermittently stopped, etc. When No in S1, this control ends.

When Yes in S1, the ECU 5 obtains the temperature T1 and the pressure P1 (S2). The temperature T1 (° C.) is the temperature of the fuel in the high-pressure delivery pipe 36 detected by the fuel temperature sensor 39. The temperature T1 may be an estimate estimated based on, for example, the temperature of the coolant of the engine 10. The pressure P1 (Pa) is the pressure of the fuel in the high-pressure delivery pipe 36 detected by the fuel pressure sensor 38. The temperature T1 and pressure P1 are the temperature and pressure of the fuel in the high-pressure delivery pipe 36 immediately after the engine 10 is stopped. S2 is an example of the process that is executed by the acquisition unit.

The ECU 5 then determines whether there is a request to start the engine 10 (S3). When No in S3, S3 is executed again. When Yes in S3, the ECU 5 acquires the temperature T2 and the pressure P2 (S4). The temperature T2 (° C.) and the pressure P2 (Pa) correspond to the temperature and pressure of the fuel in the high-pressure delivery pipe 36 just before starting the engine 10. The temperature T2 and the pressure P2 are also detected by the fuel temperature sensor 39 and the fuel pressure sensor 38, respectively. The temperature T2 may be an estimate.

The ECU 5 then starts the engine 10 (S5), and the ECU 5 measures the start time TM (S6). The start time TM is a time required from the start of cranking of the engine 10 by the starter until the start of the engine 10 is completed. When the number of revolutions of the engine 10 becomes equal to or higher than the number of revolutions capable of autonomous operation, it is considered that the start of the engine 10 is completed. S6 is an example of a process that is executed by the measurement unit.

The ECU 5 determines whether the temperature T2 is higher than the temperature T1 (S7). When Yes in S7, various processes for diagnosing a leak from the in-cylinder injection valve 37 to be described later are executed. When the temperature T2 is higher than the temperature T1, it means that the temperature T2 immediately before the engine 10 is started after being stopped is higher than the temperature T1 immediately after the engine 10 is stopped. This is because, when the temperature T2 is higher than the temperature T1, there is a possibility that the fuel has leaked from the in-cylinder injection valve 37 because the temperature of the fuel in the high-pressure delivery pipe 36 rises due to the residual heat of the engine 10 in the stopped state and the pressure rises accordingly. Therefore, when No in S7, this control ends. That is, when the temperature T2 is equal to or lower than the temperature T1, namely when there is unlikely to be a fuel leak, the fuel leak is not diagnosed. As a result, diagnostic accuracy for a fuel leak is improved. S7 is an example of a process that is executed by the determination unit.

When Yes in S7, the ECU 5 calculates the ideal pressure Pi based on the following Equation (1) (S8):

$$Pi = P 1 + ( β \times K ) \times ( T 2 - T 1 ) \qquad ( 1 )$$

where β (1/K) indicates the coefficient of thermal expansion of the fuel, K (Pa) represents the bulk modulus of the fuel, and Pi (Pa) indicates an ideal pressure of the liquid fuel (hereinafter referred to as an ideal pressure) in the high-pressure delivery pipe 36 before the engine 10 is started, assuming that there is no liquid fuel leak from the in-cylinder injection valve 37 while the engine 10 is stopped. The ideal pressure Pi is the pressure of the fuel when there is no leak of the liquid fuel from the in-cylinder injection valve 37. S8 is an example of the process that is executed by the first calculation unit.

Next, the ECU 5 calculates the amount of leakage ΔV based on the following Equation (2) (S9):

$$Δ V = ( 1 / K ) \times ( Pi - P 2 ) \times V \qquad ( 2 )$$

where V (mL) is the total volume of the space in the high-pressure delivery pipe 36, the space on the high-pressure delivery pipe 36 side than the discharge valve 60 in the discharge passage 47, and the space on the high-pressure delivery pipe 36 side than the relief valve 70 in the relief passage 49. That is, the volume V is the volume of the pressure accumulator that stores the liquid fuel discharged from the high-pressure pump 40. The amount of leakage ΔV (mL) indicates the amount of leakage of the liquid fuel from the in-cylinder injection valve 37. When the pressure P2 is lower than the ideal pressure Pi, this means that the pressure increase is insufficient even though the temperature T1 has increased to the temperature T2. Therefore, it is considered that the amount of fuel equivalent to the shortage of the pressure is leaking. S9 is an example of the process that is executed by the second calculation unit.

Next, the ECU 5 determines whether the amount of leakage ΔV is equal to or greater than a predetermined amount Vt (S10). The predetermined amount Vt is set to the smallest amount of fuel that is considered to have leaked from the in-cylinder injection valve 37 while the engine 10 is stopped, taking into account a calculation error of the amount of leakage ΔV etc. When No in S10, this control ends.

When Yes in S10, the ECU 5 determines whether the start time TM is equal to or greater than a predetermined time TMt (S11). The start time TM increases as a larger amount of fuel leaks from the in-cylinder injection valve 37 while the engine 10 is stopped. Fuel that leaks from the in-cylinder injection valve 37 while the engine 10 is stopped is vaporized and fills the cylinder. When the intake valve is open, the vaporized fuel fills the intake passage. When the engine 10 is started, the air-fuel ratio of the air-fuel mixture exceeds the ignition limit and becomes rich due to the fuel injection amount for starting and the vaporized fuel. When the fuel leaks from the in-cylinder injection valve 37 while the engine 10 is stopped as described above, the ignitability of the air-fuel mixture deteriorates and the start time TM becomes longer. Therefore, the predetermined time TMt is set to the shortest time of the start time when the fuel is considered to have leaked from the in-cylinder injection valve 37 while the engine 10 is stopped.

When Yes in S11, the ECU 5 increments the counter value N by 1 (S12). The counter value N is a counter value for diagnosing a fuel leak from the in-cylinder injection valve 37, which will be described in detail later. This is because, when the start time TM is equal to or longer than the predetermined time TMt, there is a high possibility that the fuel is leaking from the in-cylinder injection valve 37. S12 is an example of the process that is executed by the count unit.

When No in S11, the ECU 5 decrements the counter-value N by 1 (S13). This is because, when the start time TM is shorter than the predetermined time TMt, there is a high possibility of a factor other than the in-cylinder injection valve 37. Factors other than the in-cylinder injection valve 37 include, for example, a case where the increase in the fuel temperature in the high-pressure delivery pipe 36 due to the residual heat is high, and as a result, the relief pressure of the relief valve 70 is exceeded. In this case, the relieved fuel is returned to the intake passage 45 via the intake valve 50, and part of the fuel escapes from the gap between the plunger 42 and the cylinder 41. This is a normal behavior and the fuel does not leak into the cylinder. Therefore, the start time does not increase. In this way, since the counter value is decremented when the fuel is highly likely to be leaking due to a factor other than the in-cylinder injection valve 37, the diagnostic accuracy for a fuel leak from the in-cylinder injection valve 37 is improved. S13 is an example of the process that is executed by the count unit.

Next, the ECU 5 determines whether the counter value N is equal to or greater than a predetermined value Nt (S14). The predetermined value Nt is set to a counter value that can be regarded as highly likely to be leaking from the in-cylinder injection valve 37 by eliminating a temporary factor. The temporary factor is, for example, a case in which a foreign substance is temporarily caught between the needle and the injection hole of the in-cylinder injection valve 37. In this case, a fuel leak may occur temporarily. As will be described in detail later, such a temporary factor is eliminated, and a fuel leak from the in-cylinder injection valve 37 is diagnosed. Therefore, the diagnostic accuracy is improved. When No in S14, this control ends.

When Yes in S14, the ECU 5 diagnoses that there is a leak from the in-cylinder injection valve 37 (S15). S15 is an example of a process that is executed by the diagnostic unit. When it is diagnosed that there is a leak from the in-cylinder injection valve 37, the ECU 5 may notify the driver of the leak via, for example, an MIL (Malfunction Indicator Light) mounted on the vehicle, a display, or a speaker.

### Ideal Pressure Calculation Method

Next, a method for calculating the ideal pressure Pi shown in Equation (1) will be described. The bulk modulus K of the fuel can be given by the following Equation (3).

$$K = ( - 1 ) \times ( dP / dV ) \times V \qquad ( 3 )$$

Equation (3) can be modified as in the following Equation (4).

$$dV = ( - 1 ) \times ( 1 / K ) \times dP \times V \qquad ( 4 )$$

Equation (4) shows that the volume of fuel decreases by dV as the fuel pressure increases.

The coefficient of thermal expansion β of the fuel can be given by the following Equation (5).

$$β = 1 / V \times dV / dT \qquad ( 5 )$$

Equation (5) can be modified as in the following Equation (6).

$$dV = β \times dT \times V \qquad ( 6 )$$

Equation (4) shows that the volume of fuel increases by dV as the fuel temperature increases. Here, the volume of the pressure accumulator including the high-pressure delivery pipe 36 does not change. Therefore, the amount of volume decrease of Equation (4) and the amount of volume increase of Equation (5) are canceled out, and the following Equation (7) holds.

$$( - 1 ) \times ( 1 / K ) \times dP \times V + β \times dT \times V = 0 \qquad ( 7 )$$

When Equation (7) is modified, the following Equation (8) holds.

$$dP = ( K \times β ) \times dT \qquad ( 8 )$$

In this way, the amount of increase in the pressure of the fuel relative to the amount of increase in the temperature of the fuel in the case where the volume of the fuel does not change is calculated. Equation (1) for calculating the ideal pressure Pi is defined based on Equation (8) above.

It is also conceivable to calculate the ideal pressure Pi by using the gas equation. However, the equation of state of the gas is intended for an ideal gas, and an intermolecular force acts on the actual gas. For this reason, when the ideal pressure Pi is calculated by using the equation of state of the gas, its accuracy may decrease. The ideal pressure Pi is accurately calculated by considering the pressure increase of the fuel with respect to the temperature increase of the fuel on the assumption that the volume in which the fuel is stored does not change as in the present embodiment. This also improves the diagnostic accuracy for a fuel leak from the in-cylinder injection valve 37. Equation (2) is defined based on Equation (4).

Although the embodiments of the present disclosure have been described in detail above, the present disclosure is not limited to such specific embodiments, and various modifications and changes can be made within the scope of the gist of the present disclosure described in the claims.

What is claimed is:

1. A fuel leak diagnostic system comprising:
a high-pressure pump configured to pressurize liquid fuel supplied from a fuel tank;
a pressure accumulator configured to store the liquid fuel discharged from the high-pressure pump;
an in-cylinder injection valve configured to inject the liquid fuel in the pressure accumulator directly into a cylinder of an engine; and
a diagnostic device configured to diagnose a leak of the liquid fuel from the in-cylinder injection valve, wherein
the diagnostic device includes
an acquisition unit configured to acquire a first temperature and a first pressure of the liquid fuel and a second temperature and a second pressure of the liquid fuel, the first temperature and the first pressure being a temperature and a pressure of the liquid fuel in the pressure accumulator when the engine is in a stopped state, and the second temperature and the second pressure being a temperature and a pressure of the liquid fuel in the pressure accumulator after the engine is stopped and before the engine is started,
a determination unit configured to determine whether the second temperature is higher than the first temperature,
a first calculation unit configured to, when the determination unit makes an affirmative determination, calculate an ideal pressure of the liquid fuel based on the first temperature, the second temperature, the second pressure, a volume of the pressure accumulator, a coefficient of thermal expansion of the liquid fuel, and a bulk modulus of the liquid fuel, assuming that there is no leak of the liquid fuel from the in-cylinder injection valve while the engine is stopped, the ideal pressure being an ideal pressure of the liquid fuel in the pressure accumulator before the engine is started,
a second calculation unit configured to calculate an amount of leakage of the liquid fuel from the in-cylinder injection valve while the engine is stopped, based on a difference between the ideal pressure and the second pressure, and
a diagnostic unit configured to diagnose the leak of the liquid fuel from the in-cylinder injection valve, based on the amount of leakage.

2. The fuel leak diagnostic system according to claim 1, wherein:
the first calculation unit is configured to calculate the ideal pressure using the following equation:
$$Pi = P 1 + ( β \times K ) \times ( T 2 - T 1 ) ,$$
where Pi represents the ideal pressure,
P1 represents the first pressure,
β represents the coefficient of thermal expansion,
K represents the bulk modulus,
T2 represents the second temperature, and
T1 represents the first temperature; and
the second calculation unit is configured to calculate the amount of leakage using the following equation:
$$Δ V = ( 1 / K ) \times ( Pi - P 2 ) \times V ,$$
where ΔV represents the amount of leakage,
P2 represents the second pressure, and
V represents the volume.

3. The fuel leak diagnostic system according to claim 2, wherein:
the diagnostic device further includes
a measurement unit configured to measure a start time taken to start the engine, and
a count unit configured to increment a counter value when the amount of leakage is equal to or larger than a predetermined amount and the start time is equal to or longer than a predetermined time; and
the diagnostic unit is configured to diagnose that the liquid fuel is leaking from the in-cylinder injection valve, when the counter value is equal to or larger than a predetermined value.

4. The fuel leak diagnostic system according to claim 3, wherein the count unit is configured to decrement the counter value when the amount of leakage is equal to or larger than the predetermined amount and the start time is less than the predetermined time.

5. The fuel leak diagnostic system according to claim 4, further comprising a low-pressure pump configured to pressurize the liquid fuel stored in the fuel tank to supply the pressurized liquid fuel to the high-pressure pump and a port injection valve of the engine.
